(19) United States
(12) Patent Application Publication
(10) Pub. No.: US 2026/0323756 A1
(43) Pub. Date: Oct. 15, 2026

(54) SERVICE CONTINUITY FOR MULTICAST TRANSMISSION FOR STATE CHANGE

(71) Applicant: Apple Inc., Cupertino, CA (US)

(72) Inventors: Fangli Xu, Beijing (CN); Haijing Hu, Los Gatos, CA (US); Naveen Kumar R. Palle Venkata, San Diego, CA (US); Dawei Zhang, Saratoga, CA (US); Yuqin Chen, Beijing (CN); Chunhai Yao, Beijing (CN); Pavan Nuggehalli, San Carlos, CA (US); Ralf Rossbach, Munich (DE); Alexander Sirotkin, Tel Aviv (IL)

(73) Assignee: Apple Inc., Cupertino, CA (US)

(21) Appl. No.: 18/996,942

(22) PCT Filed: Jul. 22, 2022
(86) PCT No.: PCT/CN2022/107464

§ 371 Date: Jan. 17, 2025

(51) Int. Cl. H04W 76/27; H04L 12/18; H04W 36/00; H04W 36/08; H04W 76/30

(52) U.S. Cl. CPC H04W 76/27; H04L 12/1868; H04L 12/189; H04W 36/0007; H04W 36/08; H04W 76/30

(57) ABSTRACT

The present application relates to devices and components including apparatus, systems, and methods for addressing state change of a user equipment in multicast reception.

### BACKGROUND

Third Generation Partnership Project (3GPP) networks provide that for multicast transmissions between base stations and user equipment (UE). In particular, a base station may multicast transmissions to a plurality of UEs. The UEs may be in a connected state with the base station to receive the multicast transmissions from the base station. This can allow the base station to communicate data to multiple UEs at a same time.

### BRIEF DESCRIPTION OF THE DRAWINGS

FIG. 1 illustrates an example network arrangement in accordance with some embodiments.

FIG. 2 illustrates an example network arrangement in accordance with some embodiments.

FIG. 3 illustrates an example signaling chart showing lossless reconfiguration in accordance with some embodiments.

FIG. 4 illustrates an example signaling chart for a connected state to inactive state change in accordance with some embodiments.

FIG. 5 illustrates an example signaling chart for an inactive state to connected state change in accordance with some embodiments.

FIG. 6 illustrates an example procedure related to multicast data reception in accordance with some embodiments.

FIG. 7 illustrates an example procedure related to multicast data reception in accordance with some embodiments.

FIG. 8 illustrates an example procedure related to multicast data reception in accordance with some embodiments.

FIG. 9 illustrates an example user equipment (UE) in accordance with some embodiments.

FIG. 10 illustrates an example next generation NodeB (gNB) in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrase “A or B” means (A), (B), or (A and B).

The following is a glossary of terms that may be used in this disclosure.

The term “circuitry” as used herein refers to, is part of, or includes hardware components such as an electronic circuit, a logic circuit, a processor (shared, dedicated, or group) or memory (shared, dedicated, or group), an application specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, or transferring digital data. The term “processor circuitry” may refer an application processor, baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The term “interface circuitry” as used herein refers to, is part of, or includes circuitry that enables the exchange of information between two or more components of devices. The term “interface circuitry” may refer to one or more hardware interfaces, for example, buses, I/O interfaces, peripheral component interfaces, network interface cards, or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “computer system” as used herein refers to any type interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, or the like. A “hardware resource” may refer to compute, storage, or network resources provided by physical hardware element(s). A “virtualized resource” may refer to compute, storage, or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information, The terms “instantiate,” “instantiation,” and the like as used herein refers to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, virtualized network function, or the like.

The term “information element” refers to a structural element containing one or more fields. The term “field” refers to individual contents of an information element, or a data element that contains content. An information element may include one or more additional information elements.

The disclosure refers to the states of the “connected state” and the “inactive state.” These states are well known in the art and should be interpreted as known in the art.

For example, each of the “connected state” and the “inactive state” may each present at least some different features from the other states and/or may present different connections from the other states.

### MBS Enhancement

### Justification

To enable resource-efficient delivery of multicast/broadcast services, third generation partnership project (3GPP) has developed new radio (NR) broadcast/multicast in release 17 (Rel-17) according to the work item description (WID) in RP-201038, aiming to enable general multicast/broadcast service (MBS) services over fifth generation system (5GS). The use cases identified that could benefit from this feature include public safety and mission critical, vehicle to everything (V2X) applications, internet protocol television (IPTV), live video, software delivery over wireless and internet of things (loT) applications, etc. Two delivery modes have been agreed for Rel-17 MBS with delivery mode 1 (only for multicast) capable of addressing higher quality of service (QOS) services and delivery mode 2 (only for broadcast) focusing on lower QoS services. Given that Rel-17 MBS already provide the basic function to support MBS services, the general main goal for release 18 (Rel-18) should be to enable better deployment of MBS, such as improvement of resource efficiency and capacity based on Rel-17 MBS.

In Rel-17, radio access network (RAN) only specifies multicast for user equipments (UEs) in RRC_CONNECTED state, which may not fully fulfil the requirements of, e.g., Mission Critical Services, especially for cells with a large number of UEs according to TR 23.774. Also, to always keep UEs in RRC_CONNECTED state is not power efficient. It is therefore important to support multicast for UEs in RRC_INACTIVE.

The Rel-17 new radio (NR) MBS broadcast solution allows that the UE receives broadcast service in a downlink only manner i.e. performing broadcast reception without a need to access the network beforehand. However, in the typical use case for broadcast, the UE may be required to simultaneously receive broadcast service and unicast service from the network(s) of same or another operator, and some UEs may share the hardware resources between broadcast and unicast. Therefore, the unicast connection might be impacted by the broadcast reception for this kind of UEs. The optimization for such case is not specifically addressed in Rel-17, and should focus on the case of unicast reception in RRC CONNECTED and broadcast reception from the same or different operators, including emergency and public safety broadcast.

Network sharing is a common practice to reduce network capital expenditure (CAPEX). With RAN sharing deployment, if the same Multicast/Broadcast service is provided by two (or more) operators separately, this service would be recognized as separate temporary mobile group identities (TMGIs) resulting in duplicated point to multipoint (PTM) radio resources consumption in the same cell for transmission of the same content. This justifies resource efficiency improvement in the RAN sharing scenario.

Note that public safety services benefit from the Rel-17 NR MBS functions, as well as from Rel-18 enhancements that follow the above justifications.

### Objective

Objective of system information (SI) or Core part work item (WI) or Testing part WI.

This Work Item is to further enhance the NR Multicast/Broadcast functions based on Rel-17 MBS. The objectives for Rel-18 include specify support of multicast reception by UEs in RRC_INACTIVE state [radio access network group 2 (RAN2), radio access network group 3(RAN3 )], PTM configuration for UEs receiving multicast in RRC INACTIVE state [RAN2], and study the impact of mobility and state transition for UEs receiving multicast in RRC_INACTIVE (Seamless/lossless mobility is not required) [RAN2, RAN3]. The objectives further include specify Uu signalling enhancements to allow a UE to use shared processing for MBS broadcast and unicast reception, i.e., including UE capability and related assistance information reporting regarding simultaneous unicast reception in RRC CONNECTED and MBS broadcast reception from the same or different operators [RAN2], and study and, if necessary, specify enhancements to improve the resource efficiency for MBS reception in RAN sharing scenarios [RAN3]. Note: collaboration with system aspects working group 2 (SA2) is expected in due course for the above objectives.

### Issue Statement

Multicast service continuity in release 17 (R17). The multicast transmission is only supported for the connected UE. For the handover between the multicast supporting next generation NodeBs (gNBs), service continuity and lossless handover for the multicast MBS are supported during the handover. For lossless handover, it is supported for the point-to-point (PTP) to PTP or PTP to PTP+point-to-multipoint (PTM) case. For service continuity, network (NW) can provide the MBS multicast service continuity during the handover. For example, the downlink (DL) packet data convergence protocol (PDCP) sequence number (SN) synchronization and continuity between source and target cell is supported. The source gNB may forward the data from source gNB to the target gNB in order for lossless handover or minimize the interruption. UE can provide the PDCP status report for the MBS radio bearer (MRB) in the target cell, and NW can retransmit the lossless packet based on it.

For the handover between the multicast support gNB to the non-supporting gNB, core network (CN) can switch the MRB to dedicated radio bearer (DRB) and continually provide the MBS service over the radio bearer. In release 18 (R18), service continuity will be supported for the multicast MBS transmission in INACTIVE state, and some enhancements need to be considered,

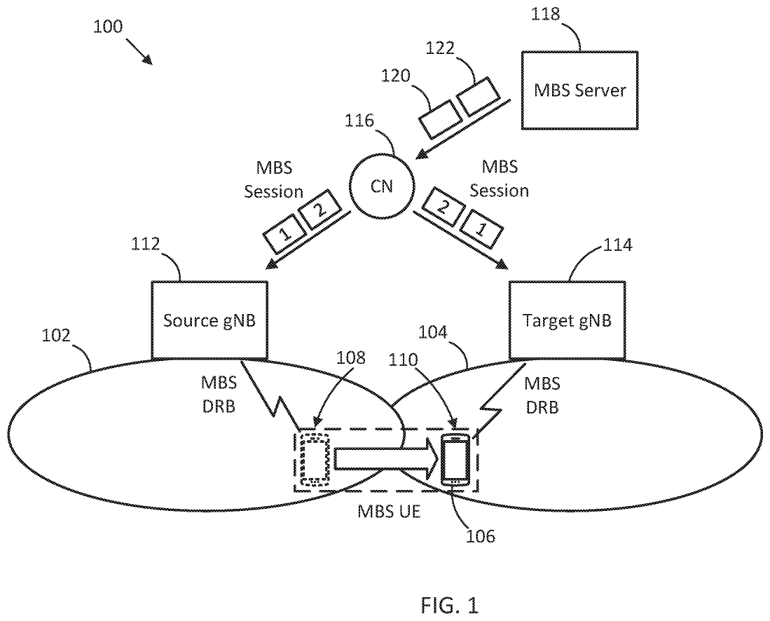

FIG. 1 illustrates an example network arrangement 100 in accordance with some embodiments. The network arrangement 100 illustrates an example UE handover from a first cell 102 that supports MBS data resource bearers (DRBs) to a second cell 104 that supports MBS DRBs.

The network arrangement 100 may include a UE 106. The UE 106 may have moved from a first position 108 (as indicated by a dotted lines version of the UE 106 shown at the first position 108) within the first cell 102 to a second position 110 within the second cell 104.

The network arrangement 100 may include a source base station 112 and a target base station 114 (both illustrated as gNBs in the illustrated embodiment). The source base station 112 may provide services for the first cell 102, where the source base station 112 may provide services to UEs located within the first cell 102. The target base station 114 may provide services for the second cell 104, where the target base station 114 may provide services to UEs located within the second cell 104. As the UE 106 moves from the first position 108 within the first cell 102 to the second position 110 within the second cell 104, a handover may be performed to hand service of the UE 106 over from the source base station 112 to the target base station 114.

The network arrangement 100 may include a CN 116. The CN 116 may be coupled to both the source base station 112 and the target base station 114. The source base station 112 and the target base station 114 may both communicate with the CN 116 to provide services.

The network arrangement 100 may include an MBS server 118. The MBS server 118 may be coupled to the CN 116. The MBS server 118 may provide an MBS session to be distributed by the CN 116, the MBS session represented by a first MBS packet 120 and a second MBS packet 122. The CN 116 may provide the first MBS packet 120 and the second MBS packet 122 to both the source base station 112 and the target base station 114. The first MBS packet 120 transmitted to both the source base station 112 and the target base station 114 may have the same SN. Further, the second MBS packet 122 transmitted to both the source base station 112 and the target base station 114 may have the same SN.

As the source base station 112 supports MBS DRBs, the UE 106 may receive the multicast data via multicast transmission when located at the first position 108. As the target base station 114 supports MBS DRBs, the UE 106 may continue to receive the multicast data via multicast transmission when located at the second position 110. Accordingly, the UE 106 may receive the multicast data via multicast transmission from the source base station 112 prior to the handover and may receive the multicast data via multicast transmission from the target base station 114 after the handover. The handover between the source base station 112 and the target base station 114 may be supported for the UE 106 being in the connected state and may provide the features for handover between multicast supporting gNBs described above.

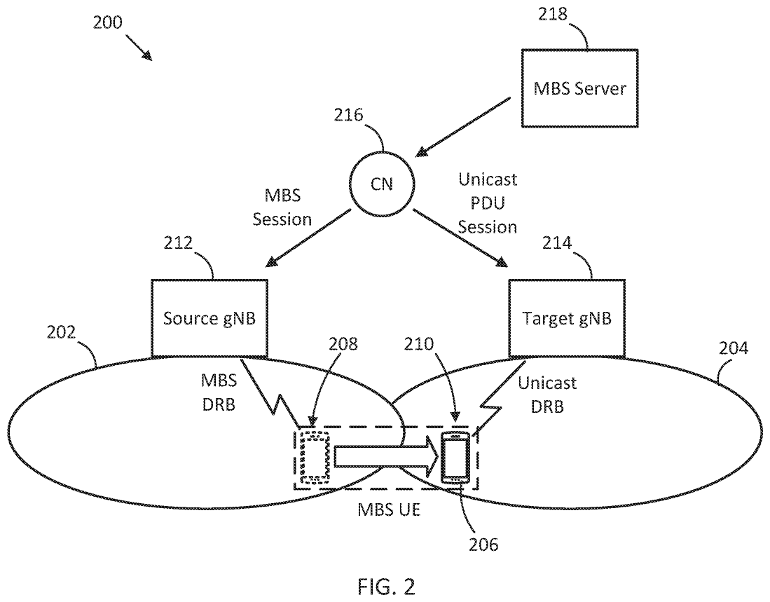

FIG. 2 illustrates an example network arrangement 200 in accordance with some embodiments. The network arrangement 200 illustrates an example UE handover from a first cell 202 that supports MBS data resource bearers (DRBs) to a second cell 204 that does not support MBS DRBs.

The network arrangement 200 may include a UE 206. The UE 206 may have moved from a first position 208 (as indicated by a dotted lines version of the UE 206 shown at the first position 208) within the first cell 202 to a second position 210 within the second cell 204.

The network arrangement 200 may include a source base station 212 and a target base station 214 (both illustrated as gNBs in the illustrated embodiment). The source base station 212 may provide services for the first cell 202, where the source base station 212 may provide services to UEs located within the first cell 202. The target base station 214 may provide services for the second cell 204, where the target base station 214 may provide services to UEs located within the second cell 204. As the UE 206 moves from the first position 208 within the first cell 202 to the second position 210 within the second cell 204, a handover may be performed to hand service of the UE 206 over from the source base station 212 to the target base station 214.

The network arrangement 200 may include a CN 216. The CN 216 may be coupled to both the source base station 212 and the target base station 214. The source base station 212 and the target base station 214 may both communicate with the CN 216 to provide services.

The network arrangement 200 may include an MBS server 218. The MBS server 218 may be coupled to the CN 216. The MBS server 218 may provide an MBS session to be distributed by the CN 216. The CN 216 may provide the MBS session to the source base station 212, where the source base station 212 supports MBS DRBs and can provide MBS session via multicast transmissions. In contrast, the target base station 214 may not support MBS DRBs and may support unicast DRB instead. The CN 216 may provide the MBS session received from the MBS as a unicast protocol data unit (PDU) session to the target base station 214 based on the target base station 214 supporting unicast DRB

As the source base station 212 supports MBS DRBs, the UE 206 may receive the multicast data via multicast transmission when located at the first position 208. As the target base station 214 does not support MBS DRBs and supports unicast DRBs, the UE 206 may receive the unicast PDU data via DRB when located at the second position 210. Accordingly, the UE 206 may receive the multicast data via multicast transmission from the source base station 212 prior to the handover and may receive the unicast PDU data via DRB from the target base station 214 after the handover. The handover between the source base station 212 and the target base station 214 may be supported for the UE 106 being in the connected state and may provide the features for handover between multicast supporting gNB and a multicast non-supporting gNB as described above.

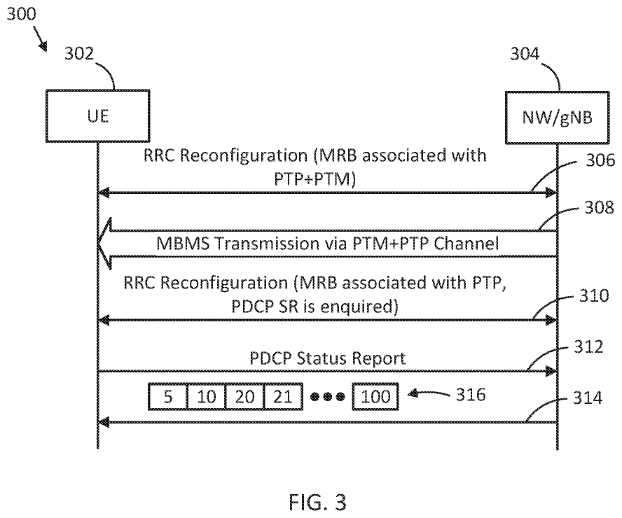

FIG. 3 illustrates an example signaling chart 300 showing lossless reconfiguration in accordance with some embodiments. For example, the signaling chart 300 illustrates signals that may be exchanged to facilitate lossless reconfiguration.

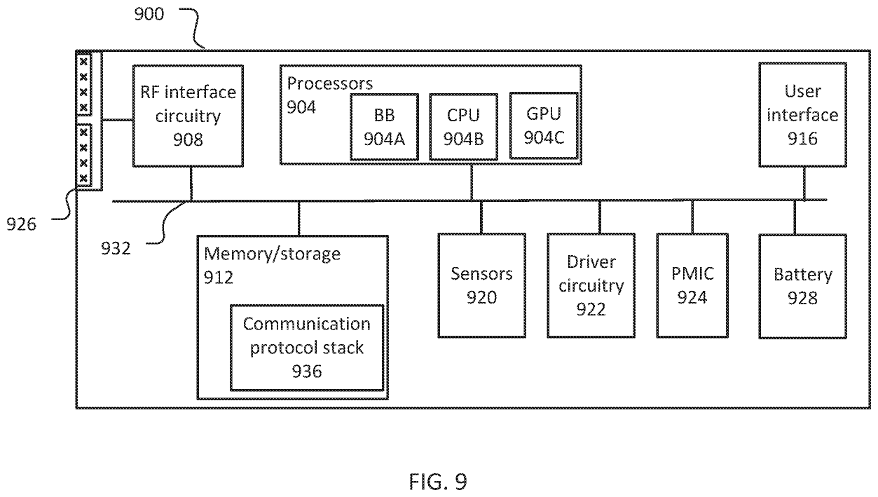

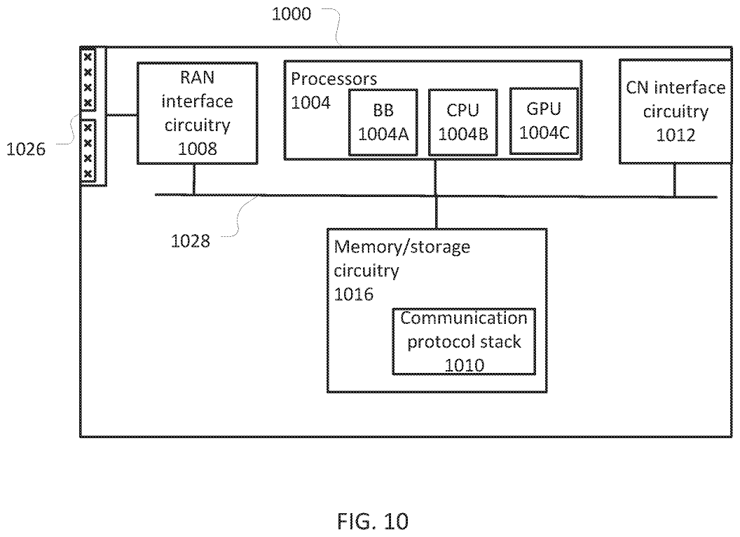

The signaling chart 300 may include a UE 302 and a network element 304. The UE 302 may include one or more features of the UE 900 (FIG. 9). The network element 304 may include one or more features of the gNB 1000 (FIG. 10). The signaling chart 300 illustrates signals that may be exchanged between the UE 302 and the network element 304 for lossless reconfiguration of the UE 302.

The signaling chart 300 may initiate with a RRC reconfiguration 306 of the UE 302. In particular, the UE 302 and the network element 304 may exchange one or more signals to reconfigure the RRC of the UE 302. The RRC reconfiguration 306 in the illustrated embodiment may reconfigure the UE 302 for MRB associated with PTP and PTM. Accordingly, the UE 302 may be reconfigured with configuration for MRB associated PTP and PTM in the illustrated embodiment.

Once the UE 302 has been configured by the RRC reconfiguration 306, the network element may transmit one or more MBS transmissions 308 to the UE 302 via a PTM channel and a PTP channel. The UE 302 may receive the MBS transmissions 308 and process the MBS transmissions 308 using the configuration indicated by the RRC reconfiguration 306. In some instances, one or more PDCP PDUs and/or service data units (SDUs) provided within the MBS transmissions 308 may not be properly received and/or processed by the UE 302.

Another RRC reconfiguration 310 may be performed between the UE 302 and the network element 304. For example, one or more signals may be exchanged between the UE 302 and the network element 304 for the RRC reconfiguration 310 to reconfigure the UE 302 with a new configuration. The RRC reconfiguration 310 may indicate a configuration of MRB with PTP in the illustrated embodiment. The RRC reconfiguration 310 may further include an indication of a PDCP status report (SR) enquiry for the UE 302. For example, the RRC reconfiguration 310 may request that the UE provide a PDCP status report.

The UE 302 may transmit a PDCP status report 312 to the network element 304. The UE 302 may transmit the PDCP status report 312 in response to the RRC reconfiguration 310. The PDCP status report 312 may indicate SNs for PDUs and/or SDUs properly received and processed by the UE 302. The PDCP status report 312 may be for the MRB. In the illustrated embodiment, the PDCP may receive and properly process PDUs and/or SDUs with SNs 6-9 and 11-19. The properly processed PDUs and/or SDUs may be stored by the UE 302. The PDCP status report 312 may indicate the SNs for the PDUs and/or the SDUs stored by the UE 302 and/or the SNs for PDUs and/or SDUs that the UE 302 determined were not properly received.

The network element 304 may transmit additional MBS transmissions 314 to the UE 302 via PTP. The MBS transmissions 314 may include PDUs and/or SDUs that were not previously properly processed by the UE 302. For example, the network element 304 may determine that the UE 302 did not properly process a PDU or SDU corresponding to SN 5 and a PDU or SDU corresponding to SN 10 based on the PDCP status report 312. The network element 304 may retransmit the PDU or SDU corresponding to SN 5 and the PDU or SDU corresponding to SN 10 in the MBS transmissions 314. In particular, the MBS transmissions 314 may include PDUs and/or SDUs 316. As can be seen the PDUs and/or SDUs 316 of the MBS transmissions 314 include the PDU or the SDU corresponding to SN 5 and the PDU or the SDU corresponding to SN 10. Upon receiving the SN 5 and the SN 10, the UE may deliver all previously stored PDCP SDUs and/or PDUs to an upper layer.

### Approach: Service Continuity During the RRC State Transition

CONNECTED to INACTIVE: The UE keeps the MBS session reception according to the RRCReconfiguration received in Connected state when switching to INACTIVE. For example, a UE may be receiving multicast data for an MBS session via an RRC configuration when the UE is in a connected state. The UE may transition from the connected state to an inactive state while continuing to receive multicast data. The UE may continue to receive multicast data via the RRC configuration while the UE is in the inactive state.

Configuration: The configuration should include at least the PTM transmission. For example, the RRC configuration that a UE utilizes for receiving and processing multicast data may include a configuration at least for a PTM transmission of the multicast data.

If the configuration in CONNECTED state includes the PTP link, UE can autonomously remove/suspend the PTP configuration part when switching to the INACTIVE (or, optionally NW can explicitly remove the PTP configuration in advance). For example, the RRC configuration for the UE may include configuration for a PTP link in the connected state that the UE can utilize for receiving the multicast data. When the UE transitions to the inactive state, the UE may remove and/or suspend the PTP link from the RRC configuration while the UE is in the inactive state. The removal and/or suspension of the PTP link may be performed autonomously by the UE or the NW may indicate that the PTP configuration is to be removed. In some embodiments, the NW may remove the PTP link prior to the UE transitioning to the inactive state, such as being indicated in an RRC release message, an RRC release with suspend configuration message, another RRC configuration message, or another message provided prior to the UE transitioning to the inactive state.

If the configuration in CONNECTED state includes the HARQ feedback part, UE can autonomously switch it into the PTM without HARQ feedback mode (or, optionally NW can explicitly reconfig the PTM configuration in advance to change the feedback mode). For example, the UE may provide HARQ feedback for multicast data received via the PTM link when the UE is in the connected state. When the UE transitions to the inactive state, the UE may switch to a PTM configuration that does not provide HARQ feedback while the UE is in the inactive state. The UE may autonomously switch to the PTM configuration that does not provide HARQ feedback or the NW may indicate that the HARQ feedback can be omitted prior to the UE transitioning to the inactive, such as being indicated in an RRC release message, an RRC release with suspend configuration message, another RRC configuration message, or another message provided prior to the UE transitioning to the inactive state.

The common frequency resource (CFR) for the multicast reception can be restricted on the initial bandwidth part (BWP) of the primary cell (PCell) for the usage in the INACTIVE state. For example, the CFR for the frequency and riming resource at the location can be restricted on the initial BWP of the PCell for the UE in the inactive state. Optionally NW can indicate the configuration can be applicable on multiple cells (cell 1,2,3). For example, the network may indicate that the configuration can be utilized for multiple cells.

UE operation: UE keeps the multicast data reception via the PTM link in the same way as in the CONNECTED state, i.e. PDCP SN is continuous. For example, the UE may receive multicast data via a PTM link when the UE is in the connected state. The UE may be configured with a configuration to receive multicast data via the PTM link when the UE is in the connected state. When the UE transitions to the active state, the UE may continue to utilize the configuration to receive multicast data via the PTM link when the UE is in the inactive state. The PDCP SN may be continuous for the multicast data may be continuous continuing from the connected state of the UE to the inactive state of the UE.

UE can stop the multicast data reception when NW informs the MBS session is deactivated or UE performs cell change. For example, the network may indicate that an MBS session is being deactivated in some instances. The UE may stop receiving multicast data based on the indication from the network that the MBS session is being deactivated. In some instances, the UE may perform a cell change. The UE may stop receiving multicast data based on the performance of the cell change.

If UE switches to other cell which has the same configuration, UE keeps on the data reception (no need to reset the layer 2 (L2) variable to receive the data in new cell). For example, the UE may continue data reception when the UE switching to another cell which has the same configuration as the cell that the UE is switching from. There may be no need to reset the L2 variable to receive data in the cell to which the UE switched.

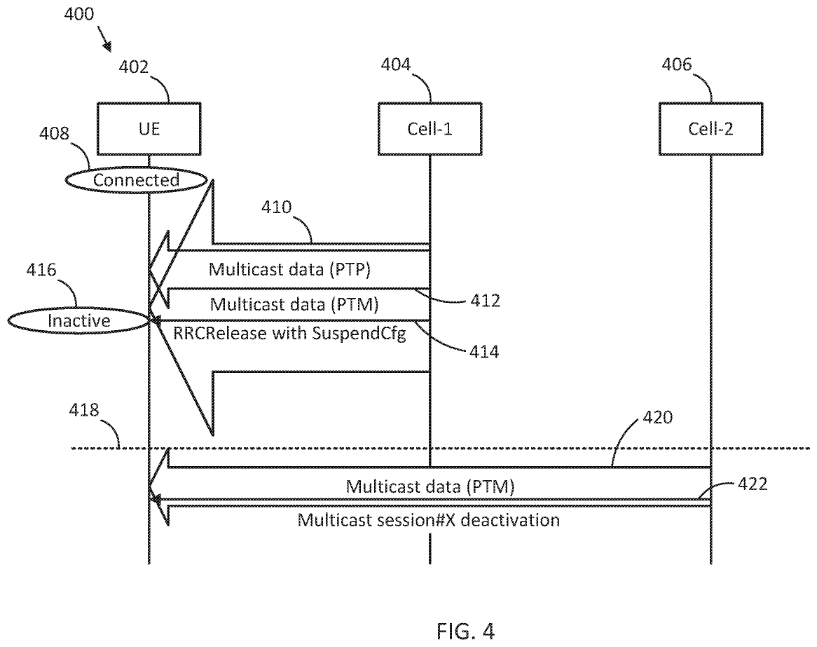

FIG. 4 illustrates an example signaling chart 400 for a connected state to inactive state change in accordance with some embodiments. For example, the signaling chart 400 illustrates an example of multicast data reception as a state of a UE is changed from the connected state to the inactive state. Further, the signaling chart 400 illustrates an example of multicast data reception as the UE performs cell reselection for a first cell to a second cell.

The signaling chart 400 may include a UE 402. The UE 402 may include one or more of the features of the UE 900 (FIG. 9). The signaling chart 400 may further include a first cell 404 and a second cell 406. Each of the first cell 404 and the second cell 406 may be provided by base stations. For example, a first base station may provide the first cell 404 and a second base station may provide the second cell 406. The first base station and the second base station may include one or more of the features of the gNB 1000 (FIG. 1). Transmissions being described as being transmitted or received by the first cell 404 may be transmitted or received via the first base station that provides the first cell 404. Further, transmissions being described as being transmitted or received by the second cell 406 may be transmitted or received via the second base station that provides the second cell 406. In other embodiments, a single base station may provide both the first cell 404 and the second cell 406, where the transmissions described for the first cell 404 and the second cell 406 may be transmitted or received by different hardware or software of the single base station.

At the initiation of the signaling chart, the UE 402 may be in a connected state, as indicated by connected 408. For example, the UE 402 may be connected to the first cell 404, where the UE 402 may maintain one or more connections with the first cell 404 while in the connected state.

The first cell 404 may transmit multicast data to the UE 402 while the UE 402 is in the connected state with the first cell 404. For example, the UE 402 may be configured with a configuration to receive multicast data via both a PTP link and a PTM link while in the connected state. Based on the configuration, the first cell 404 may transmit first multicast data 410 via a PTM link and second multicast data 412 via a PTP link to the UE 402 while the UE 402 is in the connected state.

While in the connected state, the UE 402 may utilize the configuration to receive and process the first multicast data 410 received via the PTM link and the second multicast data 412 received via the PTP link. In some embodiments, the UE 402 may provide HARQ feedback for the first multicast data 410 received via the PTM link and the second multicast data 412 received via the PTP link while the UE 402 is in the connected state.

The first cell 404 may transmit an RRC release with suspend configuration message 414 to the UE 402 to cause the UE 402 to transition to the inactive state. For example, the first cell 404 may determine that the UE 402 is to be transitioned to the inactive state based on a condition being met, such as a lack of transmissions and/or direct transmissions scheduled between the UE 402 and the first cell 404.

Based on the determination that the UE 402 is to be transitioned to the inactive state, the first cell 404 may generate the RRC release with suspend configuration message 414. In some embodiments, the RRC release with suspend configuration message 414 may indicate that the PTP link is to be removed while the UE 402 is in the inactive state and/or that HARQ feedback for the multicast data received via the PTM link is to be removed while the UE 402 is in the inactive state. In some of these embodiments, the RRC release with suspend configuration message 414 may cause the PTM configuration of the UE 402 to be reconfigured without HARQ feedback while the UE 402 is in the inactive state. Further, the RRC release with suspend configuration message 414 may indicate that the configuration for receiving multicast data is applicable for more than one cell, including the first cell 404 and the second cell 406 in the illustrated embodiment. The first cell 404 may transmit the generated RRC release with suspend configuration message 414 to the UE 402.

The UE 402 may receive and process the RRC release with suspend configuration message 414 from the first cell 404. Based on the RRC release with suspend configuration message 414, the UE 402 may transition to the inactive state, as indicated by inactive 416.

While in the inactive state, the UE 402 may remove or suspend the PTP link. For example, the UE 402 may remove or suspend the PTP link for receiving the second multicast data 412 when the UE 402 transitions to the inactive state. In some embodiments, the UE 402 may autonomously remove or suspend the PTP link when the UE 402 transitions to the inactive state. In other embodiments, the UE 402 may identify an indication from the first cell 404 that the UE 402 is to remove or suspend the PTP link while the UE 402 is in the inactive state, and the UE 402 may remove or suspend the PTP link based on the indication. When the UE 402 removes or suspends the PTP link, the UE 402 may stop receiving the second multicast data 412 via the PTP link.

In some embodiments where HARQ feedback is provided by the UE 402 for receiving multicast data while the UE 402 is in the connected state, the UE 402 may stop providing HARQ feedback for the multicast data while the UE 402 is in the inactive state. For example, the UE 402 may provide HARQ feedback for the first multicast data 410 received via the PTM link and/or the second multicast data 412 received via the PTP link while the UE 402 is in the connected state. While the UE 402 may stop receiving the second multicast data 412 via the PTP link when the UE 402 transitions to the inactive state, the UE 402 may continue to receive the first multicast data 410 received via the PTM link while the UE 402 is in the inactive state. The UE 402 may stop providing HARQ feedback for the first multicast data 410 while the UE 402 is in the inactive state. For example, the UE 402 can autonomously switch to PTM without HARQ feedback mode when the UE 402 transitions to the inactive state in some embodiments. In other embodiments, the UE 402 may have the PTM configuration reconfigured by the first cell 404 to stop providing HARQ feedback while the UE 402 is in the inactive state, such as via the RRC release with suspend configuration message 414 reconfiguring the PTM configuration of the UE 402 to not provide HARQ feedback while the UE 402 is in the inactive state.

The UE 402 may continue to receive the first multicast data 410 via the PTM link throughout the transition to the inactive state and while the UE 402 is in the inactive state. For example, the UE 402 may continue to receive the first multicast data 410 using the same configuration PTM link that was utilized while the UE 402 was in the connected state.

The PDCP SN for the multicast data being received while the UE 402 is in the inactive state may be continuous with the PDCP SN for the multicast data received while the UE 402 was in the inactive state. For example, the first multicast data 410 received via the PTM link and the second multicast data 412 received via the PTP link while the UE 402 was in the connected state may have included packets with PDCP SN that were consecutive. When the UE 402 transitions to the inactive state, the first multicast data 410 received while the UE 402 is in the inactive state may include packets with PDCP SN that are consecutive to the packets received while the UE 402 was in the connected state.

In some embodiments, the CFR for the multicast reception can be restricted on the initial BWP of the PCell for usage in the inactive state. For example, when the UE 402 is in the inactive state, the CFR for the reception of the first multicast data 410 may be restricted to the initial BWP of the first cell 404.

In the illustrated example, the UE 402 may perform a cell reselection procedure, as indicated by dotted line 418. The UE 402 may perform the cell reselection procedure based on conditions for cell reselection being met, such as a signal quality of the first cell 404 to the UE 402 falling below a threshold quality. Based on the cell reselection procedure, the UE 402 may select to camp on the second cell 406 in the illustrated example. The UE 402 may stop receiving multicast data while the UE 402 performs the cell reselection. For example, the UE 402 may stop receiving the first multicast data 410 via the PTM link and may continue to not receive the second multicast data 412 via the PTP link while the UE 402 performs the cell reselection.

Once the UE 402 completes the cell change to the second cell 406, the UE 402 may begin receiving multicast data from the second cell 406. For the illustrated example, the second cell 406 may have a same configuration for multicast data transmission as the first cell 404. In this instance, the UE 402 may receive multicast data from the second cell 406 without having to reset the L2 variable that was set for the first cell 404.

The second cell 406 may transmit third multicast data 420 on a PTM link to the UE 402 while the UE 402 is camping on the second cell 406. As the UE 402 remains in the inactive state, multicast data may be limited to PTM link transmission and PTP link transmission may not occur. In some embodiments, the third multicast data 420 may be continuous from the first multicast data 410 and/or the second multicast data 412. For example, the PDCP SN for packets received in the third multicast data 420 may be continuous with PDCP SN for packets received in the first multicast data 410 and/or the second multicast data 412. The UE 402 may utilize the same configuration for processing the third multicast data 420 received via the PTM link from the second cell 406 as was used for processing the first multicast data 410 received via the PTM link from the first cell 404.

The second cell 406 may transmit a multicast session deactivation message 422 to the UE 402. The multicast session deactivation message 422 may indicate a that a multicast session (such as multicast session #X in the illustrated example) for the UE 402 is being deactivated. The UE 402 may identify the multicast session deactivation message 422 and determine to stop receiving multicast data based on the multicast session deactivation message 422. Accordingly, the third multicast data 420 being received via the PTM link may be terminated based on the multicast session deactivation message 422.

INACTIVE to CONNECTED, the UE who are receiving the multicast data can inform the situation via the RRC resume request message. For example, a UE may transition from an inactive state to a connected state. As part of the transition from the inactive state to the connected state, the UE may transmit an RRC resume request message to the NW. The RRC resume request message may include information for continuing reception of multicast data by the UE.

If UE is receiving the multicast data in current cell and initiates the RRCResumeRequest for some reasons (e.g. unicast data arrival), UE can inform the NW about the following informations via the RRCResume procedure, i.e. together or in the RRCResumeRequest or the RRCResumeComplete: The MBS session identifier (ID) currently being received by UE; The MBS session ID UE is joint but not activated'; and/or The PDCP status report of the MRB. For example, the UE transitioning from the inactive state to the connected state may include the performance of an RRC resume procedure. The RRC resume procedure may include transmission of an RRC resume request message and/or an RRC resume complete message from the UE to the network. In some embodiments, the RRC resume request message and/or the RRC resume complete message may include an MBS session ID currently being received by the UE, an MBS session ID UE is joint but not activated, and/or a PDCP state report of the MRB.

Based on the MBS session info, NW can keep to provide the updated MBS multicast configuration to UE for the multicast transmission in CONNECTED. For example, the NW may provide an MBS multicast configuration to the UE that the UE may utilize for reception of multicast data when the UE is in the connected state. UE can keep on the multicast service reception during the whole resume procedure till receiving the dedicated multicast configuration used in CONNECTED state. For example, the UE may be receiving multicast data via a PTM link while the UE is in the inactive state. The UE may continue to receive the multicast data via the PTM link during the RRC resume procedure. Once the UE has transitioned to the connected state, the UE may receive multicast data via both the PTM link and a PTP link. The PTP link may be a dedicated multicast link and the multicast data received via the PTP link may be processed using the dedicated multicast configuration.

Based on the PDCP status report of the MRB, NW can provide the retransmission of the lost MBS packet received the INACTIVE state, and optionally NW can keep on using the PDCP context (without reset/initialisation) for the CONNECTED transmission. For example, the PDCP status report may indicate any MBS packets that were lost, failed to be properly received by the UE, and/or failed to be properly processed by the UE. The NW may determine which MBS packets were lost while the UE was in the inactive state. The NW may retransmit the lost MBS packets to the UE when the UE is in the connected state. In some embodiments, the UE may continue to utilize the PDCP context (without reset and/or initialization) for multicast transmissions provided while the UE is in the connected state.

When the RRC connection is resumed, UE can recover the previous MRB configuration, e.g. establish and resume the previous PTP link. For example, the UE may have previously been provided with an MRB configuration for multicast data received via a PTP link. When the UE has transitioned to the connected state, the UE may utilize the MRB configuration to establish and/or resume a PTP link for receiving multicast data.

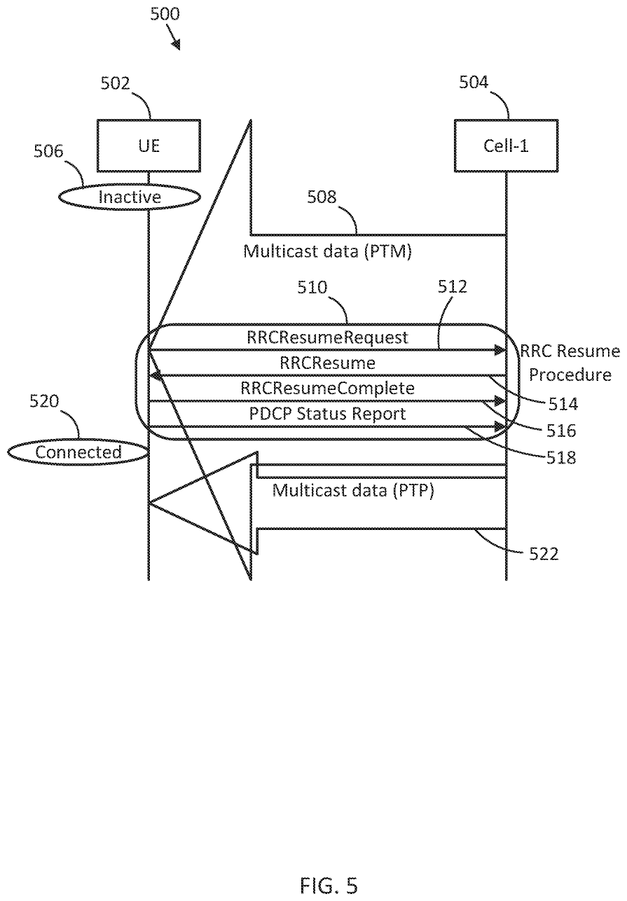

FIG. 5 illustrates an example signaling chart 500 for an inactive state to connected state change in accordance with some embodiments. For example, the signaling chart 500 illustrates an example of multicast data reception as a state of a UE is changed from the inactive state to the connected state.

The signaling chart 500 may include a UE 502. The UE 502 may include one or more of the features of the UE 900 (FIG. 9). The signaling chart 500 may further include a cell 504. The cell 504 may be provided by base station. The base station may include one or more of the features of the gNB 1000 (FIG. 10). Transmissions being described as being transmitted or received by the cell 504 may be transmitted or received via the base station that provides the cell 504.

At the initiation of the signaling chart, the UE 502 may be in a inactive state, as indicated by inactive 506. For example, the UE 502 may be camping in the inactive state on the cell 504.

While the UE 502 is in the inactive state, the UE 502 may be capable of receiving multicast data via a PTM link, but may not receive data via a PTP link. In the illustrated example, the cell 504 may receive first multicast data 508 via a PTM link to the UE 502 while the UE 502 is in the inactive state. The UE 502 may be configured with a PTM configuration for processing the first multicast data via the PTM link.

An RRC resume procedure 510 may be performed between the UE 502 and the cell 504 to transition the UE 502 to a connected state with the cell 504. The RRC resume procedure 510 may include an RRC resume request message 512 transmitted by the UE 502 to the cell 504, the RRC resume request message 512 requesting an RRC connection to be resumed. The RRC resume procedure 510 may further include an RRC resume message 514 transmitted from the cell 504 to the UE 502. The cell 504 may transmit the RRC resume message 514 in response to the RRC resume request message 512. The RRC resume procedure 510 may further include an RRC resume complete message 516 transmitted from the UE 502 to the cell 504. Further, the RRC resume procedure 510 may include a PDCP status report 518 transmitted from the UE 502 to the cell 504. The PDCP status report 518 may be a PDCP status report of the MRB related to the first multicast data 508. The UE 502 may continue receiving the first multicast data 508 via the PTM link while the RRC resume procedure 510 is being performed.

During the RRC resume procedure 510, the UE 502 may provide information related to multicast data being received by the UE 502 while the UE 502 is in the inactive state. For example, the UE 502 may provide information about the first multicast data 508 received while the UE 502 was in the inactive state to the cell 504 in the RRC resume procedure 510. The UE 502 may provide the information in the RRC resume request message 512 and/or the RRC resume complete message 516 in some embodiments. The information may include an MBS session ID for the first multicast data 508 being received at the time of the RRC resume procedure 510 and/or the MBS session ID and that the UE is joint bun not activated.

Based on the information related to the multicast data received from the UE 502 in the RRC resume procedure, the cell 504 may provide an updated MBS multicast configuration to the UE 502 for multicast transmissions while the UE 502 is in the connected state. For example, the cell 504 may provide an MBS multicast configuration for multicast data received via the PTM link and/or multicast data received via a PTP link. The UE 502 may be configured with the MBS multicast configuration and may receive multicast data via the PTP link using the MBS multicast configuration while the UE 502 is in the connected state. In some embodiments, the MBS multicast configuration may be provided in the RRC resume message 514.

Based on the RRC resume procedure 510, the UE 502 may transition to the connected state, as indicated by connected 520. Once the UE 502 is in the connected state, the cell 504 may transmit lost MBS packets to the UE 502. For example, the cell 504 may determine one or more MBS packets that were lost (including improperly received and/or improperly processed packet) by the UE 502 during reception of the first multicast data 508 while the UE 502 was in the inactive state based on the PDCP status report 518. The cell 504 may retransmit the MBS packets that were determined to be lost to the UE 502 while the UE 502 is in the connected state.

Once the UE 502 has transitioned back to the connected state, the UE 502 can recover a previous MRB configuration. The previous MRB configuration may allow the UE 502 to establish and resume a previous PTP link while the UE 502 is in the connected state. In the illustrated example, the UE 502 may receive second multicast data 522 via a PTP link that is established and resumed while the UE 502 is in the connected state. Accordingly, the UE 502 may receive the first multicast data 508 via the PTM link and the second multicast data 522 via the PTP link while the UE 502 is in the connected state.

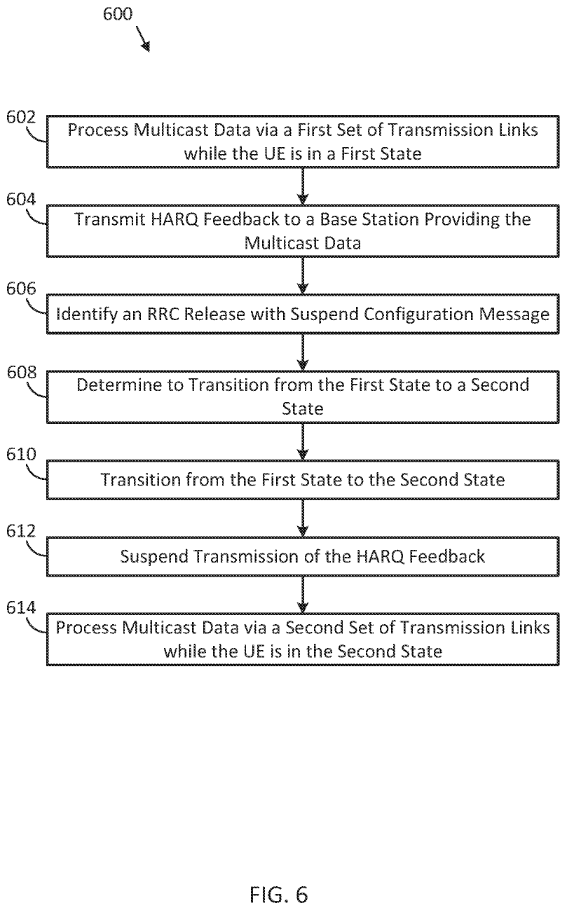

FIG. 6 illustrates an example procedure 600 related to multicast data reception in accordance with some embodiments. The procedure 600 may be performed by a UE, such as the UE 402 (FIG. 4), the UE 502 (FIG. 5), and/or the UE 900 (FIG. 9).

The procedure 600 may include processing multicast data via a first set of transmission links while the UE is in a first state in 602. For example, the UE may process multicast data via a first set of transmission links while the UE is in a first state. In some instances, the first set of transmission links may comprise a PTM link. In other instances, the first set of transmission links may comprise a PTM link and a PTP link. In some embodiments, the first state may be an inactive state. In other embodiments, the first state may be a connected state.

The procedure 600 may include transmitting HARQ feedback to a base station providing the multicast data in 604. For example, the UE may transmit HARQ feedback to a base station providing multicast data to the UE while the UE is in the first state. In some embodiments, 604 may be omitted.

The procedure 600 may include identifying an RRC release with suspend configuration message in 606. For example, the UE may identify a RRC release with suspend configuration message received from the base station. In some embodiments, the RRC release with suspend configuration message may comprise an indication of a configuration for receiving multicast data from a second base station, where the base station from which the RRC release with suspend configuration message is received is a first base station. In some embodiments, 606 may be omitted.

The procedure 600 may include determining to transition from the first state to a second state in 606. For example, the UE may determine to transition from the first state to the second state. The second state may be an inactive state in some instances, such as when the first state is the connected state. In some instances, the second state may be a connected state, such as when the first state is the inactive state. In embodiments where the first state is a connected state and the second state is an inactive state, determining to transition from the first state to the second state may comprise determining to transition from the first state to the second state based on the identification of the RRC release with suspend configuration message.

The procedure 600 may include transition from the first state to the second state in 610. For example, the UE may transition from the first state to the second state. The UE may transition from the connected state to the inactive state, or from the inactive state to the connected state. In some embodiments, transitioning from the first state to the second state may comprise performing an RRC resume procedure to transition from the first state to the second state. Performing the RRC resume procedure may comprise transmitting an RRC resume request message to a base station transmitting multicast data to the UE in some embodiments. In these embodiments, the RRC resume request message may include a MBS session identifier corresponding to multicast data being received by the UE at a time of the transitioning from the first state to the second state. Further, performing the RRC resume procedure may comprise transmitting a PDCP status report of MRB in some embodiments.

The procedure 600 may include suspending transmission of the HARQ feedback in 612. For example, the UE may suspend transmission of the HARQ feedback to the base station while the UE is in the second state. In some embodiments, 612 may be omitted.

The procedure 600 may include processing multicast data via a second set of transmission links while the UE is in the second state in 614. For example, the UE may process multicast data via a second set of transmission links while the UE is in the second state. In embodiments where the first state is the inactive state and the first set of transmission links comprise the PTM link, the second set of transmission links may comprise the PTM link and a PTP link. In embodiments where the first state is the connected state and the first set of transmission links comprise the PTM link and the PTP link, the second set of transmission links comprise the PTM link.

While an order of operations for the procedure 600 may be applied by FIG. 6, it should be understood that the order of operations may be different and/or one or more of the operations may be performed concurrently in other embodiments. Further, it should be understood that one or more of the operations may be omitted and/or one or more additional operations may be included in other embodiments.

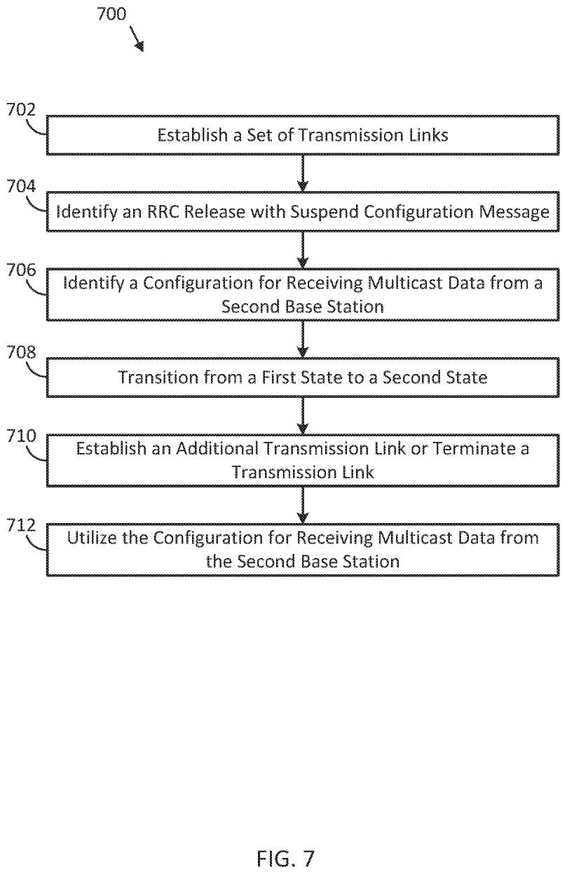

FIG. 7 illustrates an example procedure 700 related to multicast data reception in accordance with some embodiments. The procedure 700 may be performed by a UE, such as the UE 402 (FIG. 4), the UE 502 (FIG. 5), and/or the UE 900 (FIG. 9).

The procedure 700 may include establishing a set of transmission links in 702. For example, the UE may establish a set of transmission links with a base station for receiving multicast data.

The procedure 700 may include identifying an RRC release with suspend configuration message in 704. For example, the UE may identify a RRC release with suspend configuration message received from base station, where the base station may be a first base station. In some embodiments, 704 may be omitted.

The procedure 700 may include identifying a configuration for receiving multicast data from a second base station in 706. For example, the UE may identify a configuration for receiving multicast data from a second base station indicated within the RRC release with suspend configuration identified in 704. In some embodiments, 706 may be omitted.

The procedure 700 may include transitioning from a first state to a second state in 708. For example, the UE may transition from a first state to a second state. In some instances, the first state may be a connected state and the second state may be an inactive state. In some other instances, the first state may be an inactive state and the second state may be a connected state. In some embodiments, transitioning from the first state to the second state may include transmitting an RRC resume request message to the base station. The RRC resume request message may include an MBS session identifier corresponding to multicast data being received by the UE at a time of the transitioning from the first state to the second state.

The procedure 700 may include establishing an additional transmission link or terminating a transmission link in 710. For example, the UE may establish an additional transmission link or terminate a transmission link for receiving multicast data based on the transition from the first state to the second state in 708. In some instances, establishing the additional transmission link or terminating the transmission link may comprise terminating a PTP link for receiving multicast data based on the transitioning from the first state to the second state, such as when the first state is the connected state and the second state is the inactive state. In other instances, establishing the additional transmission link or terminating the transmission link may comprise establishing a PTP link for receiving multicast data based on the transitioning from the first state to the second state, such as when the first state is the inactive state and the second state is the connected state.

The procedure 700 may include utilizing the configuration for receiving multicast data from the second base station in 712. For example, the UE may utilize the configuration identified in 706 for receiving multicast data from the second base station.

While an order of operations for the procedure 700 may be applied by FIG. 7, it should be understood that the order of operations may be different and/or one or more of the operations may be performed concurrently in other embodiments. Further, it should be understood that one or more of the operations may be omitted and/or one or more additional operations may be included in other embodiments.

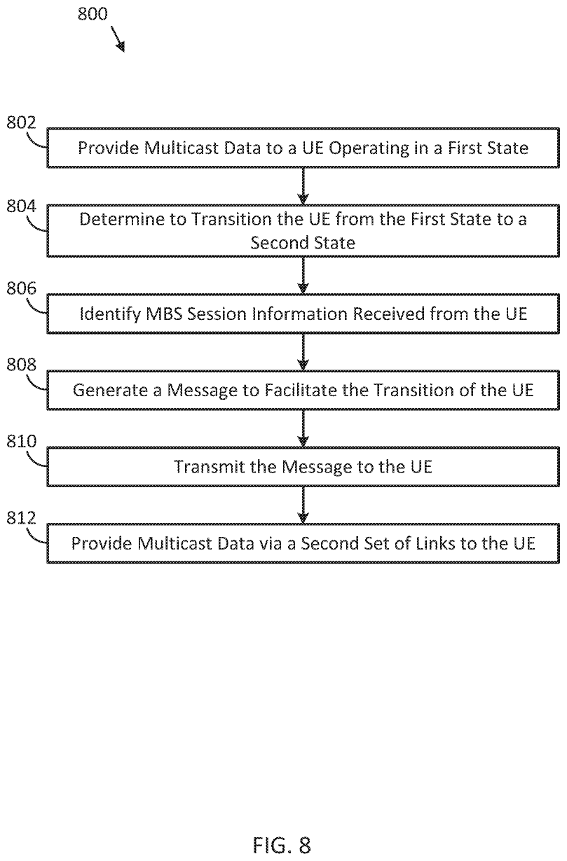

FIG. 8 illustrates an example procedure 800 related to multicast data reception in accordance with some embodiments. The procedure 800 may be performed by a base station, such as the base station that provides the first cell 404 (FIG. 4), the base station that provides the second cell 406 (FIG. 4), the base station that provides cell 504 (FIG. 5), and/or the gNB 1000 (FIG. 10).

The procedure 800 may include providing multicast data to a UE operating in a first state in 802. For example, the base station may provide multicast data to a UE operating in a first state. In some embodiments, providing the multicast data to the UE operating in the first state may comprise providing the multicast data via a first set of links to the UE when the UE is operating in the first state.

The procedure 800 may include determining to transition the UE from the first state to a second state in 804. For example, the base station may determine to transition the UE from the first state to a second state while providing the multicast data.

The procedure 800 may include identifying MBS session information received from the UE in 806. For example, the base station may identify MBS session information received from the UE. In some embodiments, 806 may be omitted.

The procedure 800 may include generating a message to facilitate the transition of the UE in 808. For example, the base station may generate a message to facilitate the transition of the UE from the first state to the second state. In some embodiments, the base station may be a first base station and the message may comprise an RRC release with suspend configuration message. The RRC release with suspend configuration message may include an indication of a configuration for receiving multicast data from a second base station. In embodiments where the MBS information is identified in 806, the message may include an indication of a multicast configuration to be utilized for reception of multicast data by the UE when the UE is operating in the second state.

The procedure 800 may include transmitting the message to the UE in 810. For example, the base station may transmit the message to the UE.

The procedure 800 may include providing multicast data via a second set of links to the UE in 812. For example, the base station may provide the multicast data via a second set of links to the UE when the UE is operating in the second state. In some embodiments, 812 may be omitted.

While an order of operations for the procedure 800 may be applied by FIG. 8, it should be understood that the order of operations may be different and/or one or more of the operations may be performed concurrently in other embodiments. Further, it should be understood that one or more of the operations may be omitted and/or one or more additional operations may be included in other embodiments.

FIG. 9 illustrates an example UE 900 in accordance with some embodiments. The UE 900 may be any mobile or non-mobile computing device, such as, for example, mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, actuators, etc.), video surveillance/monitoring devices (for example, cameras, video cameras, etc.), wearable devices (for example, a smart watch), relaxed-IoT devices. In some embodiments, the UE 900 may be a RedCap UE or NR-Light UE.

The UE 900 may include processors 904, RF interface circuitry 908, memory/storage 912, user interface 916, sensors 920, driver circuitry 922, power management integrated circuit (PMIC) 924, antenna structure 926, and battery 928. The components of the UE 900 may be implemented as integrated circuits (ICs), portions thereof, discrete electronic devices, or other modules, logic, hardware, software, firmware, or a combination thereof. The block diagram of FIG. 9 is intended to show a high-level view of some of the components of the UE 900. However, some of the components shown may be omitted, additional components may be present, and different arrangement of the components shown may occur in other implementations.

The components of the UE 900 may be coupled with various other components over one or more interconnects 932, which may represent any type of interface, input/output, bus (local, system, or expansion), transmission line, trace, optical connection, etc. that allows various circuit components (on common or different chips or chipsets) to interact with one another.

The processors 904 may include processor circuitry such as, for example, baseband processor circuitry (BB) 904A, central processor unit circuitry (CPU) 904B, and graphics processor unit circuitry (GPU) 904C. The processors 904 may include any type of circuitry or processor circuitry that executes or otherwise operates computer-executable instructions, such as program code, software modules, or functional processes from memory/storage 912 to cause the UE 900 to perform operations as described herein.

In some embodiments, the baseband processor circuitry 904A may access a communication protocol stack 936 in the memory/storage 912 to communicate over a 3GPP compatible network. In general, the baseband processor circuitry 904A may access the communication protocol stack to: perform user plane functions at a PHY layer, MAC layer, RLC layer, PDCP layer, SDAP layer, and PDU layer, and perform control plane functions at a PHY layer, MAC layer, RLC layer, PDCP layer, RRC layer, and a non-access stratum layer. In some embodiments, the PHY layer operations may additionally/alternatively be performed by the components of the RF interface circuitry 908.

The baseband processor circuitry 904A may generate or process baseband signals or waveforms that carry information in 3GPP-compatible networks. In some embodiments, the waveforms for NR may be based cyclic prefix OFDM (CP-OFDM) in the uplink or downlink, and discrete Fourier transform spread OFDM (DFT-S-OFDM) in the uplink.

The memory/storage 912 may include one or more non-transitory, computer-readable media that includes instructions (for example, communication protocol stack 936) that may be executed by one or more of the processors 904 to cause the UE 900 to perform various operations described herein. The memory/storage 912 include any type of volatile or non-volatile memory that may be distributed throughout the UE 900. In some embodiments, some of the memory/storage 912 may be located on the processors 904 themselves (for example, L1 and L2 cache), while other memory/storage 912 is external to the processors 904 but accessible thereto via a memory interface. The memory/storage 912 may include any suitable volatile or non-volatile memory such as, but not limited to, dynamic random access memory (DRAM), static random access memory (SRAM), eraseable programmable read only memory (EPROM), electrically eraseable programmable read only memory (EEPROM), Flash memory, solid-state memory, or any other type of memory device technology.

The RF interface circuitry 908 may include transceiver circuitry and radio frequency front module (RFEM) that allows the UE 900 to communicate with other devices over a radio access network. The RF interface circuitry 908 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via antenna structure 926 and proceed to filter and amplify (with a low-noise amplifier) the signal. The signal may be provided to a receiver of the transceiver that down-converts the RF signal into a baseband signal that is provided to the baseband processor of the processors 904.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 926.

In various embodiments, the RF interface circuitry 908 may be configured to transmit/receive signals in a manner compatible with NR access technologies.

The antenna 926 may include antenna elements to convert electrical signals into radio waves to travel through the air and to convert received radio waves into electrical signals. The antenna elements may be arranged into one or more antenna panels. The antenna 926 may have antenna panels that are omnidirectional, directional, or a combination thereof to enable beamforming and multiple input, multiple output communications. The antenna 926 may include microstrip antennas, printed antennas fabricated on the surface of one or more printed circuit boards, patch antennas, phased array antennas, etc. The antenna 926 may have one or more panels designed for specific frequency bands including bands in FR1 or FR2.

The user interface circuitry 916 includes various input/output (I/O) devices designed to enable user interaction with the UE 900. The user interface 916 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs, or more complex outputs such as display devices or touchscreens (for example, liquid crystal displays (LCDs), LED displays, quantum dot displays, projectors, etc.), with the output of characters, graphics, multimedia objects, and the like being generated or produced from the operation of the UE 900.

The sensors 920 may include devices, modules, or subsystems whose purpose is to detect events or changes in its environment and send the information (sensor data) about the detected events to some other device, module, subsystem, etc. Examples of such sensors include, inter alia, inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like), depth sensors; ambient light sensors; ultrasonic transceivers; microphones or other like audio capture devices; etc.

The driver circuitry 922 may include software and hardware elements that operate to control particular devices that are embedded in the UE 900, attached to the UE 900, or otherwise communicatively coupled with the UE 900. The driver circuitry 922 may include individual drivers allowing other components to interact with or control various input/output (I/O) devices that may be present within, or connected to, the UE 900. For example, driver circuitry 922 may include a display driver to control and allow access to a display device, a touchscreen driver to control and allow access to a touchscreen interface, sensor drivers to obtain sensor readings of sensor circuitry 920 and control and allow access to sensor circuitry 920, drivers to obtain actuator positions of electro-mechanic components or control and allow access to the electro-mechanic components, a camera driver to control and allow access to an embedded image capture device, audio drivers to control and allow access to one or more audio devices.

The PMIC 924 may manage power provided to various components of the UE 900. In particular, with respect to the processors 904, the PMIC 924 may control power-source selection, voltage scaling, battery charging, or DC-to-DC conversion.

In some embodiments, the PMIC 924 may control, or otherwise be part of, various power saving mechanisms of the UE 900. For example, if the platform UE is in an RRC_Connected state, where it is still connected to the RAN node as it expects to receive traffic shortly, then it may enter a state known as Discontinuous Reception Mode (DRX) after a period of inactivity. During this state, the UE 900 may power down for brief intervals of time and thus save power. If there is no data traffic activity for an extended period of time, then the UE 900 may transition off to an RRC_Idle state, where it disconnects from the network and does not perform operations such as channel quality feedback, handover, etc. The UE 900 goes into a very low power state and it performs paging where again it periodically wakes up to listen to the network and then powers down again. The UE 900 may not receive data in this state; in order to receive data, it must transition back to RRC Connected state. An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

A battery 928 may power the UE 900, although in some examples the UE 900 may be mounted deployed in a fixed location, and may have a power supply coupled to an electrical grid. The battery 928 may be a lithium ion battery, a metal-air battery, such as a zinc-air battery, an aluminum-air battery, a lithium-air battery, and the like. In some implementations, such as in vehicle-based applications, the battery 928 may be a typical lead-acid automotive battery.

FIG. 10 illustrates an example gNB 1000 in accordance with some embodiments. The gNB 1000 may include processors 1004, RF interface circuitry 1008, core network (CN) interface circuitry 1012, memory/storage circuitry 1016, and antenna structure 1026.

The components of the gNB 1000 may be coupled with various other components over one or more interconnects 1028.

The processors 1004, RF interface circuitry 1008, memory/storage circuitry 1016 (including communication protocol stack 1010), antenna structure 1026, and interconnects 1028 may be similar to like-named elements shown and described with respect to FIG. 9.

The CN interface circuitry 1012 may provide connectivity to a core network, for example, a 5th Generation Core network (5GC) using a 5GC-compatible network interface protocol such as carrier Ethernet protocols, or some other suitable protocol.

Network connectivity may be provided to/from the gNB 1000 via a fiber optic or wireless backhaul. The CN interface circuitry 1012 may include one or more dedicated processors or FPGAs to communicate using one or more of the aforementioned protocols. In some implementations, the CN interface circuitry 1012 may include multiple controllers to provide connectivity to other networks using the same or different protocols.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### EXAMPLES

In the following sections, further exemplary embodiments are provided.

Example 1 may include a method of operating a user equipment (UE), comprising processing multicast data via a first set of transmission links while the UE is in a first state, determining to transition from the first state to a second state, transitioning from the first state to the second state, and processing multicast data via a second set of transmission links while the UE is in the second state.

Example 2 may include the method of example 1, wherein the first set of transmission links comprise a point-to-multipoint (PTM) link, and wherein the second set of transmission links comprise the PTM link and a point-to-point (PTP) link.

Example 3 may include the method of example 1, wherein the first set of transmission links comprise a point-to-multipoint (PTM) link and a point-to-point (PTP) link, and wherein the second set of transmission links comprise the PTM link.

Example 4 may include the method of example 1, further comprising transmitting hybrid automatic repeat request (HARQ) feedback to a base station providing multicast data to the UE while the UE is in the first state, and suspending transmission of the HARQ feedback to the base station while the UE is in the second state.

Example 5 may include the method of example 1, wherein the first state is a connected state, and wherein the second state is an inactive state.

Example 6 may include the method of example 5, further comprising identifying a radio resource control (RRC) release with suspend configuration message received from a base station, wherein determining to transition from the first state to the second state comprises determining to transition from the first state to the second state based on the identification of the RRC release with suspend configuration message.

Example 7 may include the method of example 6, wherein the base station is a first base station, and wherein the RRC release with suspend configuration message comprises an indication of a configuration for receiving multicast data from a second base station.

Example 8 may include the method of example 1, wherein the first state is an inactive state, and wherein the second state is a connected state.

Example 9 may include the method of example 8, wherein transitioning from the first state to the second state comprises performing a radio resource control (RRC) resume procedure to transition from the first state to the second state.

Example 10 may include the method of example 9, wherein performing the RRC resume procedure comprises transmitting an RRC resume request message to a base station transmitting multicast data to the UE, wherein the RRC resume request message includes a multicast/broadcast service (MBS) session identifier corresponding to multicast data being received by the UE at a time of the transitioning from the first state to the second state.

Example 11 may include the method of example 9, wherein performing the RRC resume procedure comprises transmitting a packet data convergence protocol (PDCP) status report of multicast/broadcast service radio bearers (MRB).

Example 12 may include a method of operating a user equipment (UE), comprising establishing a set of transmission links with a base station for receiving multicast data, transitioning from a first state to a second state, and establishing an additional transmission link or terminating a transmission link for receiving multicast data based on the transition from the first state to the second state.

Example 13 may include the method of example 12, wherein the first state is a connected state, wherein the second state is an inactive state, and wherein establishing the additional transmission link or terminating the transmission link comprises terminating a point-to-point (PTP) link for receiving multicast data based on the transitioning from the first state to the second state.

Example 14 may include the method of example 12, wherein the first state is an inactive state, wherein the second state is a connected state, and wherein establishing the additional transmission link or terminating the transmission link comprising establishing a point-to-point (PTP) link for receiving multicast data based on the transitioning from the first state to the second state.

Example 15 may include the method of example 12, wherein the base station is a first base station, and wherein the method further comprises identifying a radio resource control (RRC) release with suspend configuration message received from the first base station, identifying a configuration for receiving multicast data from a second base station indicated within the RRC release with suspend configuration message, and utilizing the configuration for receiving multicast data from the second base station.

Example 16 may include the method of example 12, wherein transitioning from the first state to the second state includes transmitting a radio resource control (RRC) resume request message to the base station, wherein the RRC resume request message includes a multicast/broadcast service (MBS) session identifier corresponding to multicast data being received by the UE at a time of the transitioning from the first state to the second state.

Example 17 may include a method of operating a base station, comprising providing multicast data to a user equipment (UE) operating in a first state, determining to transition the UE from the first state to a second state while providing the multicast data, generating a message to facilitate the transition of the UE from the first state to the second state, and transmitting the message to the UE.

Example 18 may include the method of example 17, wherein providing the multicast data to the UE operating in the first state comprises providing the multicast data via a first set of links to the UE when the UE is operating in the first state, and wherein the method further comprises providing the multicast data via a second set of links to the UE when the UE is operating in the second state.

Example 19 may include the method of example 17, wherein the base station is a first base station, wherein the message comprises a radio resource control (RRC) release with suspend configuration message, and wherein the RRC release with suspend configuration message includes an indication of a configuration for receiving multicast data from a second base station.

Example 20 may include the method of example 17, further comprising identifying multicast/broadcast service (MBS) session information received from the UE, wherein the message includes an indication of a multicast configuration to be utilized for reception of multicast data by the UE when the UE is operating in the second state.

Example 21 may include an apparatus comprising means to perform one or more elements of a method described in or related to any of examples 1-20, or any other method or process described herein.

Example 22 may include one or more non-transitory computer-readable media comprising instructions to cause an electronic device, upon execution of the instructions by one or more processors of the electronic device, to perform one or more elements of a method described in or related to any of examples 1-20, or any other method or process described herein.

Example 23 may include an apparatus comprising logic, modules, or circuitry to perform one or more elements of a method described in or related to any of examples 1-20, or any other method or process described herein.

Example 24 may include a method, technique, or process as described in or related to any of examples 1-20, or portions or parts thereof.

Example 25 may include an apparatus comprising: one or more processors and one or more computer-readable media comprising instructions that, when executed by the one or more processors, cause the one or more processors to perform the method, techniques, or process as described in or related to any of examples 1-20, or portions thereof.

Example 26 may include a signal as described in or related to any of examples 1-20, or portions or parts thereof.

Example 27 may include a datagram, information element, packet, frame, segment, PDU, or message as described in or related to any of examples 1-20, or portions or parts thereof, or otherwise described in the present disclosure.

Example 28 may include a signal encoded with data as described in or related to any of examples 1-20, or portions or parts thereof, or otherwise described in the present disclosure.

Example 29 may include a signal encoded with a datagram, IE, packet, frame, segment, PDU, or message as described in or related to any of examples 1-20, or portions or parts thereof, or otherwise described in the present disclosure.

Example 30 may include an electromagnetic signal carrying computer-readable instructions, wherein execution of the computer-readable instructions by one or more processors is to cause the one or more processors to perform the method, techniques, or process as described in or related to any of examples 1-20, or portions thereof.

Example 31 may include a computer program comprising instructions, wherein execution of the program by a processing element is to cause the processing element to carry out the method, techniques, or process as described in or related to any of examples 1-20, or portions thereof.

Example 32 may include a signal in a wireless network as shown and described herein.

Example 33 may include a method of communicating in a wireless network as shown and described herein.

Example 34 may include a system for providing wireless communication as shown and described herein.

Example 35 may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

1.-20. (canceled)

21. One or more non-transitory computer-readable media having instructions stored thereon, wherein the instructions, when executed, cause processing circuitry to:
maintain a multicast/broadcast service (MBS) session for multicast data while in a connected state;
transition from the connected state to an inactive state; and
maintain the MBS session while in the inactive state.

22. The one or more non-transitory computer-readable media of claim 21, wherein the instructions, when executed, cause the processing circuitry to:
identify a radio resource control (RRC) release message related to the MBS session, wherein the transition from the connected state to the inactive state is based at least in part on the RRC release message.

23. The one or more non-transitory computer-readable media of claim 22, wherein the RRC release message indicates point to multipoint (PTM) configuration information for the inactive state.

24. The one or more non-transitory computer-readable media of claim 21, wherein:
to maintain the MBS session while in the connected state includes to maintain a point to multipoint (PTM) link while in the connected state; and
to maintain the MBS session while in the inactive state includes to maintain the PTM link while in the inactive state.

25. The one or more non-transitory computer-readable media of claim 21, wherein a common frequency resource (CFR) for the MBS session is on an initial bandwidth part (BWP).

26. The one or more non-transitory computer-readable media of claim 21, wherein a point to multipoint (PTM) configuration for the MBS session while in the connected state includes hybrid automatic repeat request (HARQ) feedback for multicast data received via a PTM link while in the connected state, and wherein the instructions, when executed, cause the processing circuitry further to:
reconfigure the PTM configuration without HARQ feedback for multicast data received via the PTM link while in the inactive state.

27. The one or more non-transitory computer-readable media of claim 21, wherein the instructions, when executed, further cause the processing circuitry to:
perform a cell reselection from a first cell to a second cell during the inactive state, wherein the first cell and the second cell have a same configuration for multicast data transmission; and
utilize the same configuration for multicast data received from the second cell during the inactive state as used for multicast data received from the first cell during the inactive state.

28. The one or more non-transitory computer-readable media of claim 27, wherein to utilize the same configuration includes to avoid reset of a layer 2 (L2) variable from the first cell to the second cell.

29. The one or more non-transitory computer-readable media of claim 27, wherein a first point to multipoint (PTM) link is utilized for multicast data transmission with the first cell, and wherein a second PTM link is utilized for multicast data transmission with the second cell.

30. A method comprising:
maintaining a multicast/broadcast service (MBS) session for multicast data while in a connected state;
identifying a radio resource control (RRC) release message related to the MBS session;
transitioning from the connected state to an inactive state based at least in part on the identification of the RRC release message; and
maintaining the MBS session while in the inactive state.

31. The method of claim 30, wherein the RRC release message indicates point to multipoint (PTM) configuration information for the inactive state.

32. The method of claim 30, wherein:
maintaining the MBS session while in the connected state includes maintaining a point to multipoint (PTM) link while in the connected state; and
maintaining the MBS session while in the inactive state includes maintaining the PTM link while in the inactive state.

33. The method of claim 30, wherein a common frequency resource (CFR) for the MBS session is on an initial bandwidth part (BWP).

34. The method of claim 30, wherein a point to multipoint (PTM) configuration for the MBS session while in the connected state includes hybrid automatic repeat request (HARQ) feedback for multicast data received via a PTM link while in the connected state, and wherein the method further comprises:
reconfiguring the PTM configuration without HARQ feedback for multicast data received via the PTM link while in the inactive state.

35. The method of claim 30, wherein a point to point (PTP) link is maintained while in the connected state, and wherein the PTP link is removed or suspended while in the inactive state.

36. The method of claim 30, wherein a first packet data convergence protocol (PDCP) sequency number (SN) for multicast data received while in the inactive state is continuous with second PDCP SN for multicast data received while in the connected state.

37. An apparatus comprising:
processing circuitry to:
generate first multicast data for transmission to a user equipment (UE) for a multicast/broadcast service (MBS) session, the first multicast data to be transmitted while the UE is in a connected state;
generate a radio resource control (RRC) release message related to the MBS session, the RRC release message to transition the UE from the connected state to an inactive state; and
generate second multicast data for transmission to the UE for the MBS session, the second multicast data to be transmitted while the UE is in the inactive state, and the MBS session to be maintained while the UE is in the inactive state; and
interface circuitry coupled with the processing circuitry, the interface circuitry to enable communication.

38. The apparatus of claim 37, wherein the RRC release message indicates point to multipoint (PTM) configuration information for the inactive state.

39. The apparatus of claim 37, wherein a common frequency resource (CFR) for the MBS session is on an initial bandwidth part (BWP).

40. The apparatus of claim 37, wherein the first multicast data is to be transmitted via a point to multipoint (PTM) link while the UE is in the connected state, and wherein the second multicast data is to be transmitted via the PTM link while the UE is in the inactive state.
